(19) United States
(12) Patent Application Publication
(10) Pub. No.: US 2010/0136402 A1
(43) Pub. Date: Jun. 3, 2010

(54) Sealed battery enclosure

(75) Inventors: Weston Arthur Hermann, Palo Alto, CA (US); Scott Ira Kohn, Redwood City, CA (US); Kurt Russell Kelty, Palo Alto, CA (US); Vineet Haresh Mehta, Mountain View, CA (US); Clay Hajime Kishiyama, San Francisco, CA (US)

Correspondence Address: PATENT LAW OFFICE OF DAVID G. BECK, P. O. BOX 1146, MILL VALLEY, CA, 94942, US

(73) Assignee: Tesla Motors, Inc., San Carlos, CA (US)

(21) Appl. No.: 12/386,684

(22) Filed: Apr. 22, 2009

(51) Int. Cl. H01M 10/50; H01M 2/08; H01M 6/42

(52) U.S. Cl. 429/120; 429/185; 429/149

(57) ABSTRACT

A sealed battery enclosure to extend the life of the batteries contained therein is provided, the sealed battery enclosure significantly reducing contamination from water or other liquids and gases.

### FIELD OF THE INVENTION

The present invention relates generally to battery cells and, more particularly, to a system for extending the life of the cells within a battery pack.

### BACKGROUND OF THE INVENTION

Batteries can be broadly classified into primary and secondary batteries. Primary batteries, also referred to as disposable batteries, are intended to be used until depleted, after which they are simply replaced with one or more new batteries. Secondary batteries, more commonly referred to as rechargeable batteries, are capable of being repeatedly recharged and reused, therefore offering economic, environmental and ease-of-use benefits compared to a disposable battery.

Although rechargeable batteries provide a much longer service life than disposable batteries, their service life is not unlimited. There are a number of factors that limit battery service life, including; (i) the number of recharging cycles the battery has been subjected to, (ii) the rate of charging (i.e., slow trickle charge versus fast charge), (iii) the level of charging (i.e., 75% of full charge, full charge, over-charged, etc.), (iv) the level of discharge prior to charging (i.e., completely depleted, still charged to a low level, etc.), (v) the storage temperature of the battery during non-use, and (vi) the temperature of the battery during use. Additionally, battery internal mechanical and chemical instability can adversely affect battery service life.

In general, the battery chemistries used in secondary cells are less stable than those used in primary cells. As a result, secondary cells often require special handling during fabrication. For example, lithium-ion batteries are typically manufactured in humidity-controlled, dry rooms and sealed to minimize subsequent water contamination. Batteries may also be manufactured in an inert atmosphere, thereby preventing cell contamination from any of a variety of reactant gases.

Batteries are sealed to prevent leakage and/or contamination from water, oxygen, carbon dioxide, or other materials. Unfortunately, battery seals are imperfect, thereby allowing gradual contamination and degradation of the batteries. One approach to overcoming this problem is to improve the battery seals. For example, U.S. Patent Application Publication No. 2003/0096162 discloses a hermetic seal that is compatible with corrosive electrolytes such as the lithium-ion electrolyte used in a lithium cell. Although improved battery seals offer one approach to overcoming contamination issues, this approach typically requires different solutions depending upon the cell chemistry and geometry in question. Accordingly, what is needed is a means of preventing cell contamination, and therefore degradation, that is universally applicable to a variety of cell chemistries and geometries. The present invention provides such a means.

### SUMMARY OF THE INVENTION

The present invention provides a sealed battery enclosure to extend the life of the batteries contained therein, the sealed battery enclosure significantly reducing contamination from water as well as other liquids and gases. The sealed battery enclosure is comprised of at least a pair of housing members configured to hold a plurality of batteries and fabricated from impermeable materials; an impermeable sealing gasket configured to fit between the sealing surfaces of the housing members; a pressure management system for limiting the pressure differential between the sealed battery enclosure and the environment; and means for maintaining the low humidity internal environment of the sealed enclosure. The housing members may be fabricated from a metal, plastic, coated plastic, composite or other impermeable material. The sealing gasket may be fabricated from a polyurethane, polychloroprene, rubber-edged composite material, PVC coated polymer, acrylic impregnated polyurethane or other impermeable material suitable for a sealing gasket. The pressure management system may be comprised of one or more pressure relief valves, preferably two-way pressure relief valves. A desiccant, for example a desiccant within one or more containers mounted within the sealed battery enclosure, may be used to maintain the low humidity internal environment. Electrical connectors used to electrically connect the batteries contained within the sealed battery pack enclosure to an outside application are hermitically sealed to the enclosure. The sealed battery pack enclosure may include means for actively cooling the batteries within the disclosure, e.g., a circulating coolant contained within a coolant line, as well as means to couple the internal cooling system to an external cooling system, e.g., a conduit coupler hermitically sealed to the enclosure. The battery enclosure may be evacuated and may be back-filled with dry air or an inert gas.

A further understanding of the nature and advantages of the present invention may be realized by reference to the remaining portions of the specification and the drawings.

### BRIEF DESCRIPTION OF THE DRAWINGS

FIG. 1 is a perspective view of a preferred embodiment of battery pack enclosure fabricated in accordance with the invention; and

FIG. 2 is a cross-sectional view of an alternate sealing arrangement.

### DESCRIPTION OF THE SPECIFIC EMBODIMENTS

In the following text, the terms “battery”, “cell”, and “battery cell” may be used interchangeably and may refer to any of a variety of different rechargeable cell chemistries and configurations including, but not limited to, lithium-ion (e.g., lithium iron phosphate, lithium cobalt oxide, other lithium metal oxides, etc.), lithium-ion polymer, nickel metal hydride, nickel cadmium, nickel hydrogen, nickel zinc, silver zinc, or other battery type/configuration. The term “battery pack” as used herein refers to multiple individual batteries contained within a single piece or multi-piece housing, the individual batteries electrically interconnected to achieve the desired voltage and capacity for a particular application. It should be understood that identical element symbols used on multiple figures refer to the same component, or components of equal functionality. Additionally, the accompanying figures are only meant to illustrate, not limit, the scope of the invention and should not be considered to be to scale.

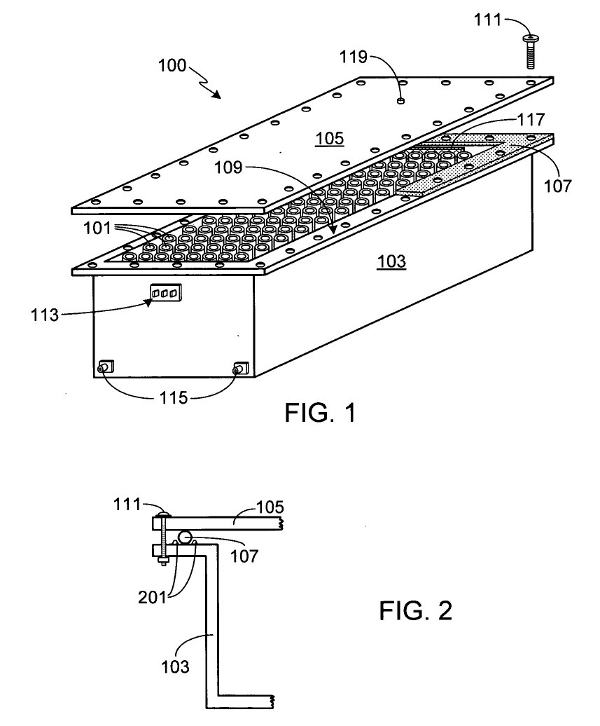

FIG. 1 is a perspective view of a preferred embodiment of a battery pack enclosure fabricated in accordance with the invention. As shown, a plurality of individual batteries 101 are mounted within a multi-piece impermeable enclosure, the enclosure preferably comprised of a lower housing member 103 and an upper housing member 105. It should be understood that the invention is not limited to a specific battery chemistry or geometry, nor is it limited to a specific number of cells. Consequently, details of batteries 101 and the battery interconnects are not provided herein.

Lower housing member 103 and upper housing member 105 are fabricated from a material or materials that are impermeable to water and water vapor, and preferably impermeable in general to other liquids and gases. Additionally, as the housing members are intended to contain a plurality of cells, in some instances hundreds or thousands of cells, the housing members are fabricated from materials capable of handling the weight of the cells for the intended application. Preferably one or both housing members 103/105 are fabricated from a metal, for example aluminum or an alloy such as steel. Alternately, one or both housing members may be fabricated from a plastic or a high strength, lightweight composite such as a carbon composite. In some instances, the use of such a material may require coating the material with an impermeable layer, e.g., a metal layer. The impermeable layer can be added using any of a variety of well-known coating techniques, e.g., vapor deposition. The addition of an impermeable coating, as required, allows the selection of the material used for the housing members to be based on the material's mechanical and electrical properties (e.g., high strength, low weight, high structural rigidity, electrically and thermally non-conductive), rather than its liquid and gas impermeability.

In order to achieve the desired enclosure impermeability, a compressible and impermeable seal 107, also referred to herein as a sealing gasket, is interposed between the complimentary and mating surfaces of lower housing member 103 and upper housing member 105. A portion of sealing gasket 107 is shown in FIG. 1. Those of skill in the art will recognize that there are countless materials from which seal 107 can be fabricated, exemplary materials including, but not limited to, polyurethanes, polychloroprenes, rubber-edged composite materials, coated (e.g., PVC coated) polymers, uncoated polymers, synthetic rubbers (e.g., butyl rubber), and acrylic impregnated polyurethanes.

Preferably lower housing member 103 includes a flange 109 onto which sealing gasket 107 is positioned. In the illustrated embodiment, upper housing member 105 is flat, however, in embodiments in which a non-flat upper housing member is used, the upper housing member also includes a flange that is complimentary to flange 109. Enclosure 100 includes means, for example a plurality of bolts 111, for compressing seal 107 and holding together the housing members. Bolts 111 may also be used to attach enclosure 100 to the mounting structure of the intended application, for example to the mounting bay of an electric vehicle.

Although in the preferred embodiment shown in FIG. 1 a flat sealing gasket is used, it will be appreciated that the invention is not so limited. For example, an alternate arrangement is shown in FIG. 2. This figure provides a cross-sectional view of a portion of an enclosure prior to compression of the seal. As shown, in this embodiment sealing gasket 107 has a circular cross-section prior to compression. Preferably one or both flanges include a compression stop 201, thus preventing over compression of the seal. Stops 201 can also be designed to allow registration of the seal on the flange during the assembly process.

In order to protect cells 101 from environmentally induced degradation, all connections to the internal volume of enclosure 100 must be hermitically sealed. Thus, for example, electrical connections 113 are hermitically sealed to lower housing member 103. Similarly, if coolant lines or other means are used to actively withdraw heat from the battery pack, the coolant lines/connections 115 must also be hermitically sealed to the enclosure.

Although enclosure 100 is designed to prevent the intrusion of water vapor, thereby protecting cells 101, it will be appreciated that during the lifetime of a battery pack, the batteries may still be subjected to an undesirable and potentially harmful amount of water vapor, for example due to gasket leakage, hermitic seal leakage, coolant system leakage, and the out-gassing of the various materials used for the cells, cell interconnects, cooling system, and internally packaged electronics. Accordingly, in a preferred embodiment of the invention, means are included within enclosure 100 to actively remove water vapor. Although any of a variety of techniques can be used to collect and remove water vapor, in a preferred embodiment of the invention, one or more containers of desiccant 117 are mounted within enclosure 100, desiccant 117 removing water from within enclosure 100 via absorption and/or adsorption. Preferably the amount of desiccant 117 included within enclosure 100 is based on the size of enclosure 100 and the expected lifetime of the enclosed battery pack, thus insuring that desiccant 117 does not have to be prematurely replaced in order to maintain the low humidity environment of the enclosure.

In a preferred embodiment of the invention, a pressure management system is used to ensure that the pressure differential between the inner volume of the enclosure and the outside environment stays within a predetermined range. Preferably the pressure management system is comprised of one or more pressure relief valves 119 coupled to enclosure 100, for example via upper housing member 105. Preferably pressure relief valve or valves 119 are two-way valves. Pressure relief valve 119 ensures that the pressure differential between the inner enclosure volume and the outside environment does not become large enough to cause structural damage to the enclosure. Although in general pressure differentials are caused by the battery pack being moved to a different altitude, and thus subjected to a different external pressure, pressure differentials can also arise due to component out-gassing, battery cell venting, temperature changes, etc. In order to minimize water vapor entering the enclosure via the relief valve, the valve has preset relief points. The pressure relief set point can be different depending upon the direction of release, i.e., inwardly or outwardly venting, or can utilize the same set point. In one embodiment, the pressure relief set point is 1 psi in either direction.

Preferably during battery pack fabrication the entire assembly process is performed in a humidity controlled, dry room. Once the battery pack and enclosure is fully assembled and sealed, preferably enclosure 100 is partially evacuated in order to further reduce water contamination, and then back-filled with dry air or an inert atmosphere.

The benefits of the present invention were tested over a relatively short period of time, i.e., six months. During this period of time, a plurality of 18650 form factor lithium-ion cells were maintained in a sealed enclosure in accordance with the invention, thereby ensuring that the cells were exposed to a very low humidity environment. During this same period of time, a second plurality of 18650 form factor lithium-ion cells were maintained outside of the sealed enclosure, thus exposing this second plurality of cells to a higher humidity environment. Both sets of cells were stored at 4.1 volts and at a temperature of 40° C. At the conclusion of the six-month test period, the percentage energy capacity retention for each cell was measured, this figure illustrating each cell's capacity fall-off. The inventors found that for this period of time, the capacity fall-off for those cells maintained in the low humidity environment was less than that of the cells maintained in the high humidity environment, the difference ranging from 0.3% to 0.6%, with an average of 0.5%. Clearly in those applications requiring long term battery use, for example electric vehicles where the desired battery life is on the order of five to ten years, this difference can amount to several percent, and thus be quite significant.

As will be understood by those familiar with the art, the present invention may be embodied in other specific forms without departing from the spirit or essential characteristics thereof.

What is claimed is:

1. A sealed battery pack enclosure, comprising:
a first housing member configured to hold a plurality of batteries, wherein said first housing member is comprised of a first impermeable material;
a second housing member configured to be coupled to said first housing member, wherein said second housing member is comprised of a second impermeable material;
an impermeable sealing gasket configured to fit between a first sealing surface corresponding to said first housing member and a second sealing surface corresponding to said second housing member;
means to secure said first housing member to said second housing member with said impermeable sealing gasket interposed between said first and second sealing surfaces;
a pressure management system coupled to said sealed battery pack enclosure, wherein said pressure management system limits a pressure differential between an inner volume of said sealed battery pack enclosure and the outside environment; and
means for maintaining a low humidity environment within said inner volume of said sealed battery pack enclosure.

2. The sealed battery pack enclosure of claim 1, wherein said first and second impermeable materials are selected from the group consisting of metals, plastics and composites.

3. The sealed battery pack enclosure of claim 1, wherein said first impermeable material is comprised of a base material and a coating of an impermeable material.

4. The sealed battery pack enclosure of claim 1, wherein said second impermeable material is comprised of a base material and a coating of an impermeable material.

5. The sealed battery pack enclosure of claim 1, wherein said impermeable sealing gasket is comprised of a gasket material selected from the group consisting of polyurethanes, polychloroprenes, rubber-edged composite materials, coated polymers, uncoated polymers, synthetic rubbers, and acrylic impregnated polyurethanes.

6. The sealed battery pack enclosure of claim 1, wherein said securing means is comprised of a plurality of bolts.

7. The sealed battery pack enclosure of claim 1, wherein said pressure management system is comprised of at least one pressure relief valve.

8. The sealed battery pack enclosure of claim 7, wherein said at least one pressure relief valve is a two-way pressure relief valve.

9. The sealed battery pack enclosure of claim 1, wherein said means for maintaining said low humidity environment is comprised of a desiccant.

10. The sealed battery pack enclosure of claim 1, wherein said means for maintaining said low humidity environment is comprised of at least one container of desiccant mounted within said inner volume of said sealed battery pack enclosure.

11. The sealed battery pack enclosure of claim 1, further comprising at least one electrical connector hermitically sealed to said sealed battery pack enclosure, said at least one electrical connector electrically connected to said plurality of batteries.

12. The sealed battery pack enclosure of claim 1, further comprising:
means for actively cooling said plurality of batteries; and
means for coupling said means for actively cooling said plurality of batteries with an external cooling source, wherein said coupling means is hermitically sealed to said sealed battery pack enclosure.

13. The sealed battery pack enclosure of claim 12, wherein said means for actively cooling said plurality of batteries is comprised of a liquid coolant contained within a coolant line in thermal communication with said plurality of batteries, and wherein said coupling means is a coolant line coupler.

14. The sealed battery pack enclosure of claim 1, wherein said sealed battery pack enclosure is partially evacuated and back-filled with an inert gas.

15. The sealed battery pack enclosure of claim 1, wherein said sealed battery pack enclosure is partially evacuated and back-filled with dry air.

16. A sealed battery pack enclosure, comprising:
a first housing member configured to hold a plurality of batteries, wherein said first housing member is comprised of a first impermeable material, and wherein said first housing member further comprises a mounting flange;
a second housing member configured to be coupled to said mounting flange of said first housing member, wherein said second housing member is comprised of a second impermeable material;
an impermeable sealing gasket interposed between said mounting flange of said first housing member and a corresponding sealing surface of said second housing member;
means to secure said first housing member to said second housing member with said impermeable sealing gasket interposed between said mounting flange of said first housing member and said corresponding sealing surface of said second housing member;
at least one two-way pressure relief valve coupled to said sealed battery pack enclosure, wherein said at least one two-way pressure relief valve limits a pressure differential between an inner volume of said sealed battery pack enclosure and the outside environment;
at least one container of desiccant mounted within said inner volume of said sealed battery pack enclosure; and
at least one electrical connector hermitically sealed to said sealed battery pack enclosure, said at least one electrical connector electrically connected to said plurality of batteries.

17. The sealed battery pack enclosure of claim 16, further comprising:
means for actively cooling said plurality of batteries; and
means for coupling said means for actively cooling said plurality of batteries with an external cooling source, wherein said coupling means is hermitically sealed to said sealed battery pack enclosure.

18. The sealed battery pack enclosure of claim 17, wherein said means for actively cooling said plurality of batteries is comprised of a liquid coolant contained within a coolant line in thermal communication with said plurality of batteries, and wherein said coupling means is a coolant line coupler.

19. The sealed battery pack enclosure of claim 16, wherein said sealed battery pack enclosure is partially evacuated and back-filled with an inert gas.

20. The sealed battery pack enclosure of claim 16, wherein said sealed battery pack enclosure is partially evacuated and back-filled with dry air.
